(19) United States
(12) Patent Application Publication
(10) Pub. No.: US 2005/0121477 A1
(43) Pub. Date: Jun. 9, 2005

(54) Sipper cap with a reciprocally movable nozzle

(76) Inventor: Edward Scott, Auckland (NZ)

Correspondence Address: EDWARDS & ANGELL, LLP, P.O. BOX 55874, BOSTON, MA, 02205, US

(21) Appl. No.: 10/499,396

(22) PCT Filed: Dec. 18, 2002
(86) PCT No.: PCT/NZ02/00284

(30) Foreign Application Priority Data
Dec. 18, 2001 (NZ) 516300

(51) Int. Cl. B67D 3/00; B67D 5/06

(52) U.S. Cl. 222/522

(57) ABSTRACT

Sipper cap (10) includes a cap section (30) with a housing, a nozzle (50) reciprocally movable in the housing and an overcap (70). The sipper cap is adapted to provide a releasable single point seal between the housing and the nozzle capable of preventing passage of liquid through the sipper. The cap section (30) has a neck section (38) that provides a vertical guide for movement of the nozzle member. The point seal is formed between the end of angle surface (44) of an inwardly directed extension (43) and sealing face (57b) on the outer wall of the nozzle (50). The extension (43) also engages with a retention part (56) on a seal piercing part (54) to prevent removal of the nozzle (50) from the sipper cap. The overcap (70) and cap section (30) can each have a tamper evident ring (71, 34).

### FIELD OF THE INVENTION

This invention relates to sipper caps for containers and more specifically for bottles used in the beverage industry. As will be readily apparent the sipper cap could be used in industries other than the beverage industry so this should not be seen as limiting. The invention also relates to a means to assist in preventing removal of the nozzle in a sipper cap thus enhancing the safety of such caps.

### BACKGROUND TO THE INVENTION

Sipper caps have found considerable application in the beverage industry. Sipper caps are commonly fitted to the top of drink bottles and provide access to the content of the bottle. By moving a nozzle member, which forms part of the sipper cap assembly, the content of the bottle can be accessed by the user or retained within the bottle as desired. Such cap & could be attached to a variety of other containers as well, however, they are commonly used with drink bottles.

Induction seals and/or foils are often secured to the neck of drink bottles to which sipper caps are attached. The induction seal contains the content of the bottle within the bottle prior to purchase of the drink bottle by the consumer. The seal is provided to prevent contact by air and/or contaminants with the contents in the bottle. Induction seals also provide the consumer with a quality assurance.

Sipper caps have also been developed which have the ability to pierce the induction seal. This is advantageous as it overcomes the need to remove the cap manually, remove the seal, and replace the cap before drinking from the sipper cap.

Currently available sipper caps both with and without piercing means can have a number of disadvantages. The content of the bottle often leaks out of the bottle via the sipper cap due to inadequate sealing between the nozzle of the cap and the body of the sipper cap that houses the nozzle. Another is the need for a seal at the top of the bottle to which the cap is attached. Piercing options for caps have been used to address the need to remove the seal on the bottle before use but the closure seal in the cap itself is often not as secure as might be desired.

There would be an advantage in providing a sipper cap that includes a secure seal to prevent problems with leakage and which may also offer an alternative to the need to seal the bottle separately to the cap.

There is also a problem with sipper caps as the nozzle can sometimes be removed by vigorous movement when opening the sipper cap. It would be an advantage to assist in prevention of such removal.

### OBJECT OF THE INVENTION

It is an object of the invention to provide a sipper cap which overcomes or at least reduces at least some of the disadvantages of presently available sipper caps or which at least provides the public with a useful alternative.

Other objects of the invention may become apparent from the following description which is given by way of example only.

### SUMMARY OF THE INVENTION

According to one aspect of this invention there is provided a sipper cap for engagement with container, the sipper cap including a housing and a nozzle reciprocally movable in the housing and wherein the sipper cap is adapted to provide a releasable seal between the housing and the nozzle capable of preventing passage of liquid through the sipper cap.

Preferably a single point seal is provided about the nozzle.

Preferably the single point seal is formed by interaction of a concentric extension from the housing that is adapted to interact with a sealing face about the nozzle.

Preferably the concentric extension includes an angled surface that interacts directly with a sealing face on the nozzle.

Preferably the angled surface is at an angle of between about 30° and about 70° from the central longitudinal axis of the housing.

Preferably the angled surface is an angle of between about 45° and about 60°.

Preferably the angled surface is at an angle of about 55° to the central longitudinal axis of the sipper cap.

In another aspect the invention provides a sipper cap including a nozzle and a housing wherein the nozzle is reciprocally movable in the housing from a closed position to an open position and, when in the closed position, a seal is created by an interaction between a concentric extension from the housing and the external surface of the nozzle.

Preferably the sipper cap includes an induction seal at the point of interaction between the concentric extension and the nozzle surfaces.

Preferably the concentric extension includes an angled surface that interacts directly with sealing face on the nozzle.

Preferably the angled surface is at an angle of between about 30° and about 70° from the central longitudinal axis of the housing.

Preferably the angled surface is an angle of between about 45° and about 60°.

Preferably the angled surface is at an angle of about 55° to the central longitudinal axis of the sipper cap.

In another aspect the invention provides a container including a sipper cap as described above wherein the sipper cap includes an induction seal at the point of interaction between the concentric extension and the nozzle and optionally another induction seal at the point of contact between the s container and the sipper cap.

Preferably the nozzle for use in the sipper cap described above includes at least two windows for passage of fluid through the sipper cap, the passage of fluid through the window being preventable by the interaction of the concentric extension from the housing and the nozzle.

In a further embodiment the invention provides a sipper cap for attachment to a container, the sipper cap including a nozzle and a housing, wherein the nozzle is reciprocally movable within the housing from a first to a second open position, and from the second open position to a closed position, and wherein the nozzle is restricted in movement from the first open position to the second open position, and to and from the closed position, and wherein when the nozzle is in the closed position a seal is created by an interaction between a concentric extension from the housing, and the external surface of the nozzle preventing passage of liquid through the sipper cap.

Preferably the container does not have a seal independent of the sipper cap and the container is purchased with the sipper cap having the nozzle in the closed position.

Preferably the container does have a seal independent of the sipper cap and the container is purchased with the sipper cap having the nozzle in the first open position.

Preferably the concentric extension includes an angled surface that interacts directly with sealing face on the nozzle.

Preferably the angled surface is at an angle of between about 30° and about 70° from the central longitudinal axis of the housing.

Preferably the angled surface is an angle of between about 45° and about 60°.

Preferably the angled surface is at an angle of about 55° to the central longitudinal axis of the sipper cap.

In another aspect, the invention provides a housing for a sipper cap nozzle, the housing including a concentric extension with an angled end surface, the extension adapted to interact with the nozzle at the angled end surface to provide a releasable seal preventing passage of liquid through the nozzle and sipper cap.

Preferably the concentric extension includes an angled surface that interacts directly with sealing face on the nozzle.

Preferably the angled surface is at an angle of between about 30° and about 70° from the central longitudinal axis of the housing.

Preferably the angled surface is an angle of between about 45° and about 60°.

Preferably the angled surface is at an angle of about 55° to the central longitudinal axis of the sipper cap.

In another aspect, the invention provides a sipper cap for attachment to a container, the sipper cap including a housing and a nozzle, the nozzle being reciprocally movable within the housing from an open position allowing passage of liquid to a closed position preventing passage of liquid from the container, wherein the nozzle includes a retention part adapted to prevent removal of the nozzle from the housing.

Preferably the retention part is at the end of the nozzle which, when the sipper cap is attached to the container, is adapted to be positioned adjacent the container.

Preferably the nozzle includes a nozzle housing adapted to allow passage of liquid therethrough, the nozzle housing having an open end and a partially closed end, wherein the nozzle also includes an arm extending from the partially closed end of the nozzle housing through the open end of the nozzle housing, the arm Including at least one wing extending from the end of the arm distal the partially closed end of the nozzle and being capable of preventing removal of the nozzle from the sipper cap. In another aspect, the invention provides a nozzle for a sipper cap, the nozzle including a housing adapted to allow passage of liquid therethrough, the housing having an open end and a partially closed end, wherein the nozzle also includes an arm extending from the partially closed end through the housing and the open end of the nozzle, the arm including at least one wing extending from the end of the arm distal the partially closed end of the nozzle and being capable of preventing removal of the nozzle from the sipper cap.

Preferably the wing extends at an angle of between about 70° and about 110°, more preferably about 90°, from the central longitudinal axis of the arm.

Preferably the arm includes two wings and the end of the arm distal the partially closed end of the nozzle is substantially a “T” shape.

Preferably the arm extends along the central longitudinal axis of the nozzle.

### DESCRIPTION OF THE FIGURES

The invention may be better understood with reference to the following Figures which illustrate the preferred embodiment, in which:

FIG. 1: shows a cross-section of a sipper cap of a preferred embodiment where the sipper cap is in an “open/purchase” conformation on a container having a seal;

FIG. 2: shows a cross-section of the sipper cap of FIG. 1 in which the cap is in a open/seal pre-piercing position;

FIG. 3: shows a cross-section of the sipper cap of FIGS. 1 and 2 where the sipper cap is in an intermediate conformation in which the seal has just been pierced;

FIG. 4: shows a cross-section of the sipper cap, in which the sipper cap is in a “closed” conformation that prevents the content of the bottle escaping from the bottle;

FIG. 5: shows an alternative cross-section through section B-B of the sipper cap of FIG. 1, 90° to section D-D;

FIG. 6: shows a perspective view of the external features of the nozzle of the sipper cap of FIGS. 1 to 5;

FIG. 7: shows a perspective view of an alternative form of the nozzle of the sipper cap excluding seal piercing means.

FIGS. 8 and 9: show a cross-section of a standard sipper cap, in which the nozzle includes a retention part preventing the nozzle being easily removed from the cap.

FIG. 10: shows a nozzle of use in the sipper cap of FIGS. 8 and 9.

### DESCRIPTION OF THE INVENTION

The invention of the present application is broadly directed to a sipper cap that includes an improved flow position and an improved seal in comparison to existing options. The invention can be applied to sipper caps that include an induction foil piercing means, or that do not. Manufacture of a bottle/cap arrangement without induction foil on the bottle can be achieved using the improved seal arrangement of the present invention.

It will be appreciated that the sipper cap herein described is not restricted to use with containers which hold consumable beverages. This sipper cap may have application in any industry where liquid (or gas) is to be stored in a bottle and released as required. The sipper cap as herein described may be fitted to any number of different bottles, or types of bottles, without departing from the scope or spirit of the invention.

The cap itself and/or any part thereof may be made of any suitably rigid material including plastics, stainless steel or aluminium, as would be known to a person skilled in the art. The cap and its component parts are preferably produced using a plastics material and formed by injection moulding or compression moulding. The plastics material used will preferably be a polypropylene or a polyethylene of a variety of grades as will be well known. Alternative methods of moulding can also be used as will be known by those skilled in the art.

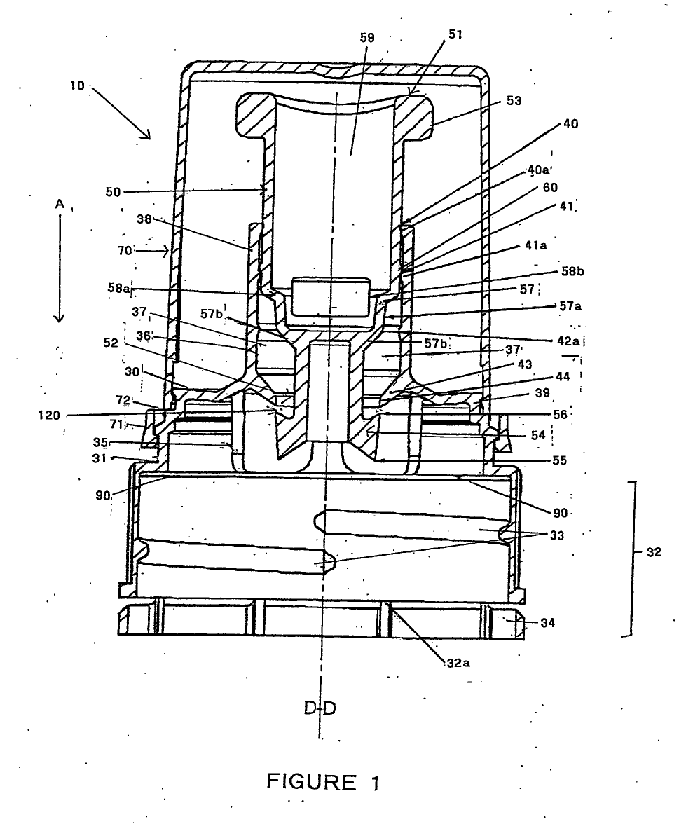

A sipper cap of the preferred embodiment is illustrated in FIG. 1. The sipper cap 10 as illustrated in FIGS. 1 to 5 is adapted for use with a container including an induction seal not shown but which would be positioned at 90. Where an induction seal has been fitted to the bottle, as is standard at present, the sipper cap 10 attached to the bottle may be purchased by a consumer in the conformation as shown in FIG. 1.

The sipper cap 10 of FIG. 1 includes a cap section 30; a nozzle member 50; and an overcap 70. It will be appreciated that the overcap 70 is not essential to the operation of the sipper cap 10 and is present merely to reduce incidental damage to the nozzle member 50 which may allow leakage from the sipper cap 10. The overcap 70 also includes a tamper evident ring 71 which is integrally associated with the overcap 70, via connection means 72. The overcap 70 may be removed from the cap section 30 by breaking the connection means 72. This breaks the connection between overcap 70 and the tamper evident ring 71. If the overcap 70 has been removed, and/or tampered with, the ring 71 drops towards cap surface 31. It is therefore visually apparent that the association between the tamper evident ring 71 and the overcap 70 has been broken. Other tamper evident means as will be well known (eg shrink wrap plastic etc) could also be used. Alternatively the overcap, if present, need not have tamper evident means but this is less preferred.

As seen in FIG. 1, the cap section 30 includes a neck section 38; a top section 39; and the bottle engagement means 32. Neck section 38 provides a vertical guide for movement of the nozzle member 50 within the sipper cap 10. Top section 39 provides support for overcap 70 and extends to include bottle engagement means 32.

The bottle engagement means 32 includes a screw thread 33, engageable with a bottle thread screw top (not shown). Also included is tamper evident ring 34 which is attached to sipper cap 10 via tabs 32a. Tabs 32a are frangible and will break leaving the ring 34 as visual evidence of use (ie its absence or presence on the bottle).

As mentioned previously, the sipper cap 10 may be integrally associated with a bottle. In this case the bottle engagement means 32 and tamper evident ring 34 will not be necessary. To this extent the invention can be seen to provide a housing which is adapted to receive a nozzle, the housing being optionally integral with a container such as a bottle, the housing and nozzle being as described herein.

In the preferred embodiment shown in FIG. 1, the nozzle member 50 includes an outlet end 51 and a sealing end 52. The outlet end 51 includes a grip 53 adapted to allow the nozzle member 50 to be gripped by the user and moved manually within the sipper cap 10. The grip 53 is contoured to allow the user to easily move the nozzle member 50 with their teeth or fingers for example.

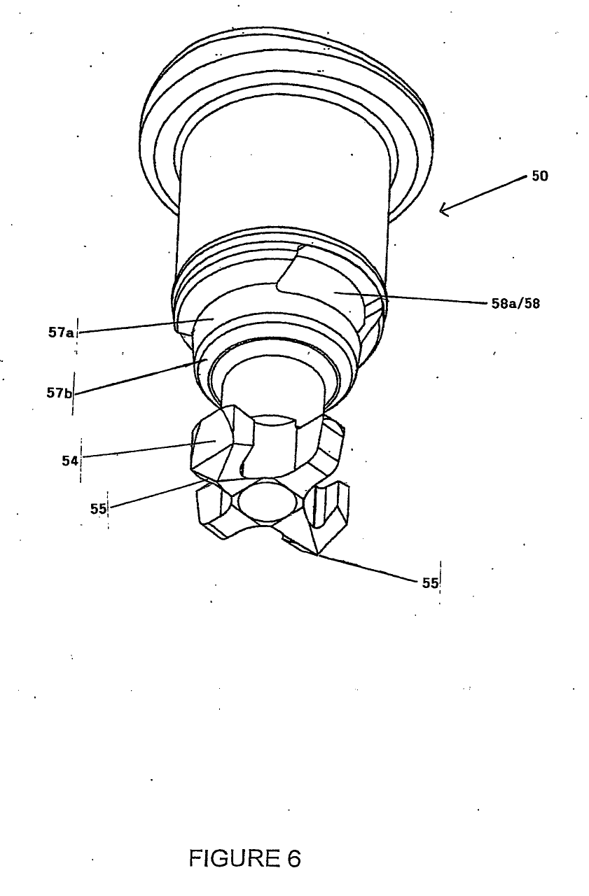

As shown in FIG. 1, the sealing end 52 of the nozzle member 50 includes a seal piercing part 54, distal to outlet end 51 on nozzle member 50, adapted to pierce a seal, such as induction seal 90, at the top of the bottle (not shown) to which the sipper cap 10 is attached. It will be appreciated that when an induction seal 90 is not required, it will be unnecessary for the sealing end 52 to include a piercing part 54. This is best seen with reference to FIG. 6.

The piercing part 54 resides between seal support arms 35 formed in tip section 30. The piercing part 54 includes the piercing means 55. The piercing means 55 may be of any design but will need to be capable of piercing the foil and/or the induction seal 90 which isolates the liquid in the bottle (not shown) from the sipper cap 10. Seal support arms 35 protect seal 90 from piercing means 55 when the product as a whole is put together. As a secondary effect, the arms 35 protect piercing means 55 when the cap 10 itself is being formed or stored.

The piercing part 54 of nozzle member 50 also includes a retention part 56, distal piercing means 55 on piercing part 54. The retention part 56 contacts with the extension 43 to prevent removal of the nozzle member 50 from the cap section 30. This is a safety feature of value to the use of sipper caps. There is an advantage in being able to prevent ready removal of the nozzle from the sipper cap as, if the nozzle is accidentally removed when opening the cap using the user's teeth for example, there is the possibility that the nozzle would be swallowed and possibly cause the user to choke. Less important issues include spillage on the user amongst other factors.

Nozzle member 50 has a contoured, stepped, outer wall 57 adapted to engage with the inner wall 36 of the neck section 38 of the cap section 30.

It will be understood that the outer wall 57 is not restricted exactly to the form and/or shape illustrated in the Figures, however it will be appreciated that outer wall 57 should be adapted to allow for movement of the nozzle member 50 within the neck section 38 of the sipper cap 10. Outer wall 57 includes shoulder 57b and sealing face 57a, as well as a series of protrusions adapted to form a number of seals and clips with associated protrusions on inner wall 36.

The neck section 38 includes a wiper seal 40; a retention clip seal 41; and a locking clip 42. Each is formed by the interaction of a series of protrusions on inner wall 36 and outer wall 57 of nozzle member 50.

The wiper seal 40 is created by protrusion 40a at the top end of neck section 38, that forms a tight, friction seal with the outer wall 57 of nozzle member 50. The wiper seal 40 is adapted to ensure that no residue leaks out between the nozzle member 50 and the cap section 30 when the sipper cap 10 is in an open conformation.

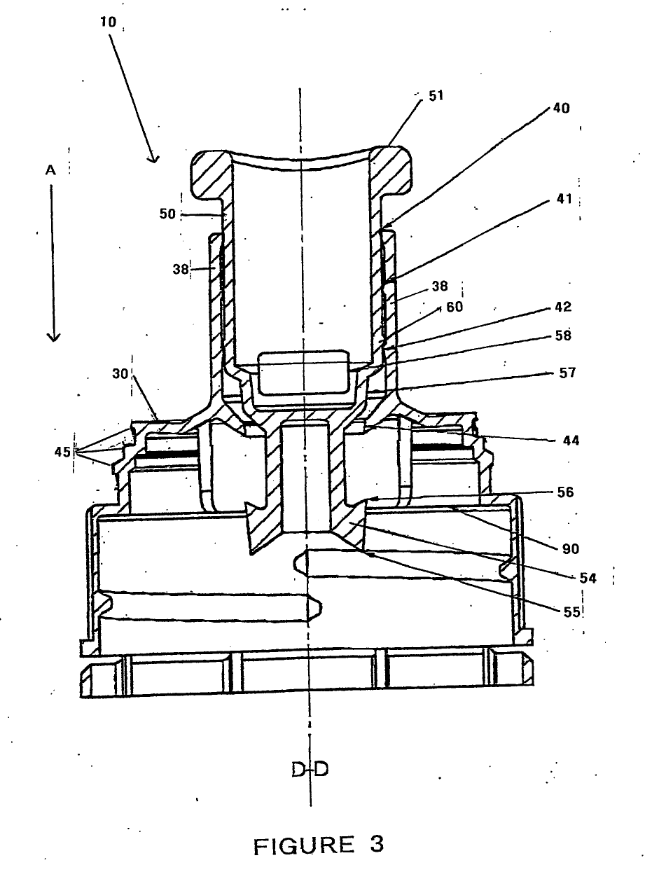

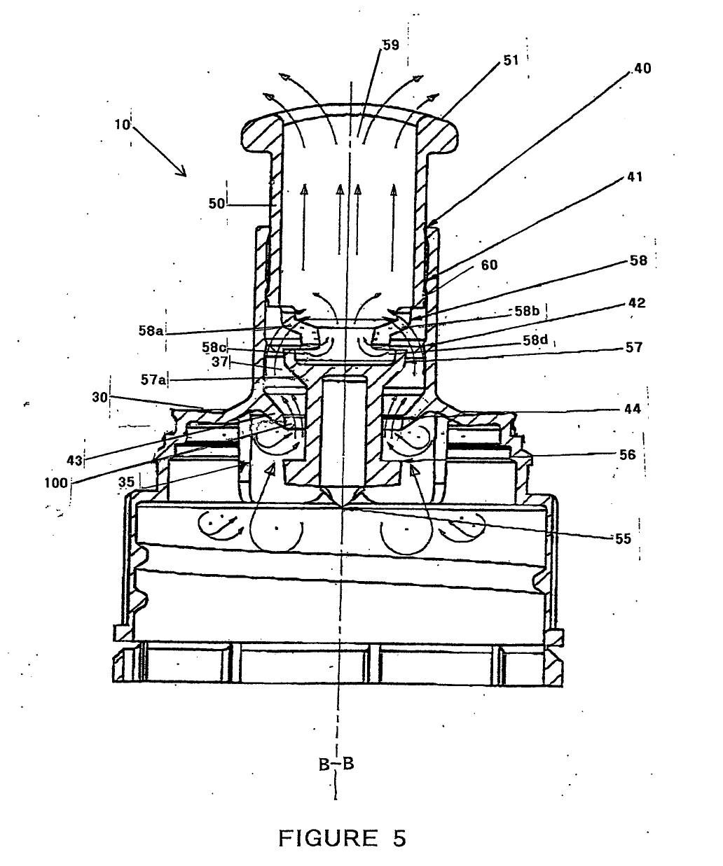

The clip seal 41 provides a method of retaining the nozzle member 50 in a first open conformation, restricting movement, and assisting in preventing accidental damage of the seal 90 when in the purchase condition. In the preferred embodiment, the clip seal 41 is formed by engagement of protrusion 41 a on inner wall 36 with a ring 60 formed on the outer wall 57 of the nozzle member 50. Damage and/or pressure applied to the nozzle member 50 may cause the induction seal 90 to be broken. The clip seal 41 increases the force required to move the nozzle member 50 from the first open position to the second open position (FIGS. 3 and 5) and further toward seal 90, thus minimising the risk of unintended nozzle movement. In this way additional protection for seal 90 to that provided by overcap 70 is given.

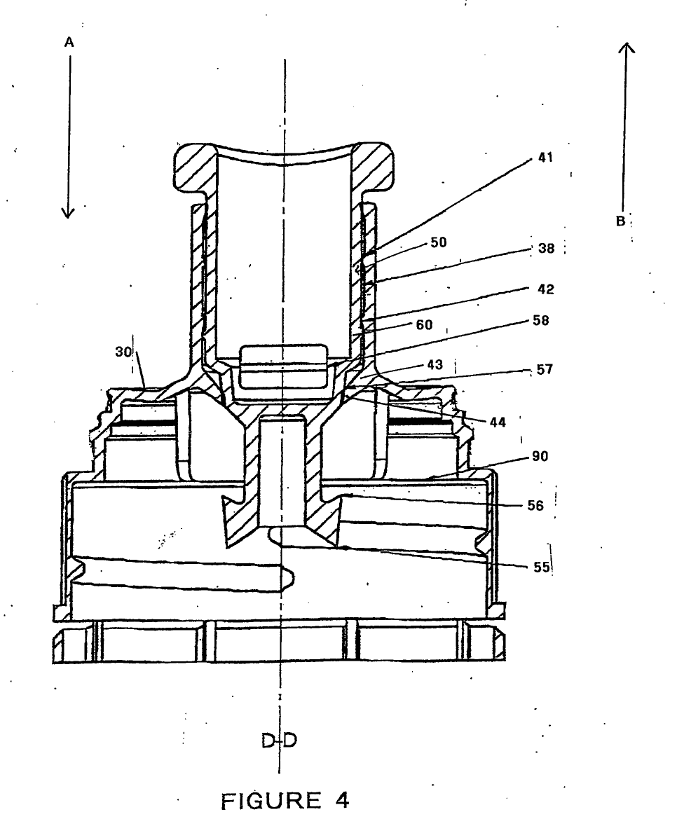

The ring 60 of the nozzle member 50 also engages with protrusion 42a on inner wall 36 to form lock clip 42 (See FIG. 1. and FIG. 4). In the closed conformation, shown in FIG. 4, lock clip 42 via ring 60 firmly holds the nozzle member 50 in the desired closed conformation restricting further movement of the nozzle member 50 toward the bottle (not shown) and toward the open nozzle positions.

A closure seal is formed by interaction of the outer wall 57, and extension 43 having an angled surface 44. Extension 43 extends inwardly towards the nozzle member 50 and downwardly toward the bottle (not shown) at an angle of about 45° to vertical axis D-D, and engages with sealing face 57a of outer wall 57 of nozzle member 50 when the sipper cap 10 is in the closed conformation (FIG. 4). The 45° angle is not essential and can vary as will be apparent to the skilled person. An angle of between about 30° and about 60° will be preferred however. A surface at 90° to the vertical axis D-D would work to an extent but would create problems in use. The sealing surface of extension 43 in this option would simply abut surface 57b which would also preferably be at 90° to axis D-D.

The extension 43 and the angled surface 44 are concentric and the angled surface 44 is at an angle of substantially 55° to the vertical axis D-D, although this specified angle can be varied (as will be apparent to the skilled person). An angular aspect is preferred as this allows ease of use and maximises the sealing with face 57a, resulting in maximised sealing effect. The angle could vary quite widely (eg 30° to 70°) but will preferably be between about 45° and about 60°. As will be appreciated, the angled surface 44 could lie parallel to axis D-D. In this option, which is less preferred, it would be preferable for sealing face 57a to also lie parallel to axis D-D. The interference created between the surfaces would be sufficient to create a seal but it would not be as secure as preferred options.

The closure seal is created at a single point about the nozzle member 50 of cap 10 and is capable of preventing passage of liquid through the cap 10. A single point seal is preferable but, provided sufficient interference is created between the nozzle and the housing this may suffice.

The nozzle member 50 includes at least two windows 58a and 58b positioned in the wall 57 of the nozzle member 50 to allow passage of liquid. The windows 58a/58b are adapted to allow liquid to pass from the bottle via support arms 35 and inner chamber 37 of the cap section 30 to an inner chamber 59 of the nozzle member 50 and out through outlet end 51, when the sipper cap 10 is in the open conformation (FIG. 1 and FIG. 5). When in its closed conformation (FIG. 4) liquid is prevented from reaching the windows 58a/58b.

In the preferred embodiment as shown in FIG. 1, the windows 58a and 58b are oppositely disposed on nozzle member 50. In this preferred form the windows 58a and 58b act to lessen the vacuum created by passage of liquid from the outlet end 51 of the sipper cap 10. The size, shape and number of the windows 58 may depend on a number of factors including the liquid stored in the bottle; the size of the bottle and the size of the sipper cap 10.

The stepped shape of the outer wall 57 of the nozzle member 50 and its interaction with the inner wall 36 of cap section 30 reduces the likelihood of drips spills that may occur when the sipper cap 10 is lowered from the consumer's mouth. Wall 57 channels liquid from the inner chamber 37 of the cap section 30 back into the bottle once the bottle is lowered from the consumer's mouth.

An induction seal 90 may be affixed to the top of the bottle (not shown), to which the sipper cap 10 is attached, by known means, although this is not essential with the cap according to the instant invention. Alternatively if the sipper cap 10 is integrally formed with the bottle, an induction seal or seals could be directly associated with the sipper cap 10 as will be discussed later herein.

Preferably the induction seal 90 is formed from foil. The foil may be manufactured from aluminium and include a heat sensitive adhesive layer on one side. The induction seal 90 may preferably be fitted into the cap section 30, resting on a suitable ledge which, when a sipper cap 10 is fitted to the bottle, allows the induction seal 90 and adhesive layer to rest on the open neck of the bottle. The heat sensitive adhesive may, when passed through or by an electromagnetic field and/or any other method known to those skilled in the art, fuse the induction seal 90 to the bottle via the adhesive.

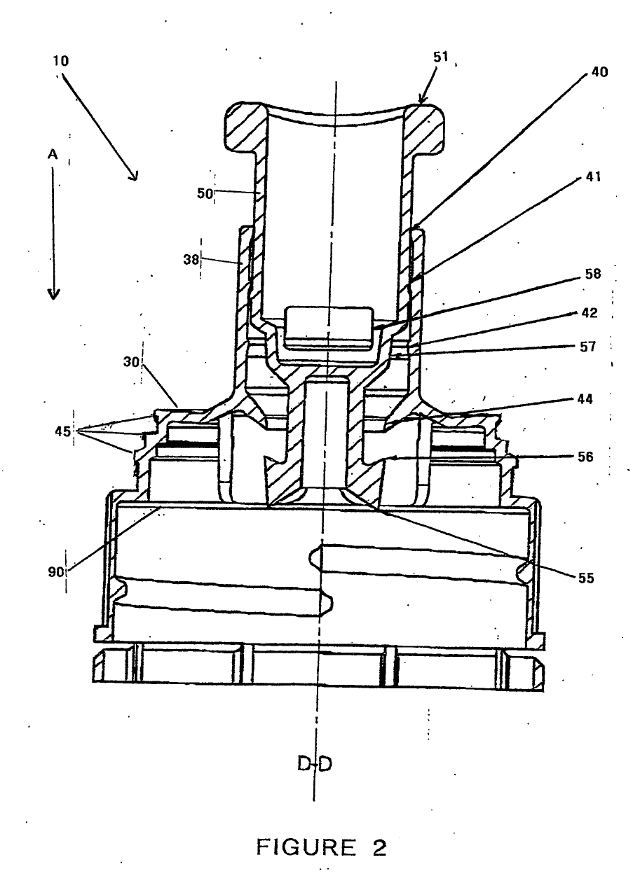

With reference to FIGS. 2 to 4, movement of the sipper cap 10 from a first position (open-seal not broken) to a second position (closed-seal pierced) is shown. Reference to FIG. 1 and FIG. 2 shows movement from a first open position, where movement of nozzle 50 is restricted in direction of arrow A, to a second open position, where movement of nozzle 50 is less restricted in direction of arrow A.

FIG. 2 shows the sipper cap 10 in an intermediate position where the seal 90 is about to be broken by piercing means 55. In this position the clip seal 41 has changed position (with respect to the position shown in FIG. 1) from a first to a second open position.

FIG. 3 shows the sipper cap 10 with the seal 90 pierced. This is again an intermediate position between the first open position (FIG. 1) and the closed position (FIG. 4). Ring 60 has not passed protrusion 42a to move to the confirmation for lock clip 42 to hold the nozzle member 50 in the final, closed position.

FIG. 4 then shows the sipper cap in the closed position. The lock clip 42 is in place releasably holding the nozzle member 50 in position. In this position the interaction between extension 43 at angled surface 44 and face 57a of outer wall 57 of nozzle member 50 provides a firm seal preventing flow of liquid from the bottle (not shown). The interaction between extension 43 at angled surface 44 and face 57a blocks channel 120. The extension 43 is adapted to flex in response to urging, first by shoulder 57b and then face 57a thus forming a firm and secure seal between surface 44 and extension 43. The nozzle member 50 is held at this position by lock clip 42 and friction/interference within the seal formed.

The seal formed is at a single point about nozzle member 50 and is sufficient to allow for the option of preparing a bottle and sipper cap combination that does not require an induction seal at the top of the bottle. This may result in a shorter product shelf life if an induction seal of some sort is not used, but this may be acceptable commercially.

The seal will preferably form a point seal between the end of angled surface 44 and face 57a with the pressure being applied to the point of contact by the urging of extension 43. In one embodiment the cap could be attached to the bottle in this closed position at point of sale, and simple upward movement would open the bottle for use. The provision of an induction or similar seal between extension 43 and face 57a is also an option. This could be coupled with a similar seal in the contact area between the bottle and the sipper cap (eg engagement area 32) if desired. This would result in simplicity of consumer use while maintaining product integrity and shelf life. Removal of the need for a piercing means in the cap would result in lower material costs as well.

When the sipper cap does include the single point seal (FIGS. 1 to 7) extension 43 has a dual role. The first role is to interact via angled surface 44 with sealing face 57b on nozzle 50 to form the single point concentric seal preventing liquid flow through the sipper cap. The second role is to interact with retention part 56 on piercing part 54 to prevent removal of nozzle 50 from the sipper cap.

In use and with reference to FIGS. 1 to 5, the nozzle member 50 is held by neck section 38 of the cap section 30 above and/or in close proximity to the induction seal 90 (open/purchase conformation—FIG. 1).

The induction seal 90 is pierced by the nozzle 50 of sipper cap 10 moving from the first open/purchase conformation (FIG. 1) to the “closed” conformation shown in FIG. 4 via the intermediate positions shown in FIGS. 2 and 3.

The induction seal 90 is broken by the user applying downward pressure to the outlet end 51 of the nozzle member 50 in the direction of arrow A. When pressure is applied in this way the engagement at clip seal 41 is broken. This pressure also brings the piercing means 55 into contact with the induction seal 90 (FIG. 2).

Continued pressure in the direction of arrow A pushes the piercing means 55 through the induction seal 90 (FIG. 3). Shoulder 57b then forces concentric extension 43 away from its rest position and, as nozzle member 50 continues in the direction of arrow A, face 57a comes into sealing contact with angled surface 44 of extension 43. The angled surface 44 prevents the escape of the liquid from the bottle as pressure is exerted at this point by face 57a pressing on extension 43. This allows secure contact between the face 57a and angled surface 44. There will be maximised force applied to the contact area between these two parts as a result of this interaction.

To prevent the content of the bottle escaping via the sipper cap 10 once the induction seal 90 has been pierced, the sipper cap 10 is closed. FIG. 4 illustrates the closed conformation of the preferred embodiment.

The movement of fluid from the bottle into the cap section 20 may be better understood with reference to FIG. 5 which shows a cross section of the cap 10 of FIG. 1 through line B-B. Upturning the bottle or applying pressure to the sides of the bottle facilitates movement of liquid from the bottle Into the sipper cap 10 as shown by the arrows in FIG. 5. Liquid passes by supporting arms 35 of cap section 30 and enters the inner chamber 37 of the cap section 30 via channel 120. Once in the inner chamber 37, liquid passes into the chamber 59 of the nozzle member 50 via windows 58a and 58b. Liquid exits the sipper cap 10 via the outlet end 51 of the nozzle member 50.

When the consumer lowers the bottle, liquid in the lower part of the inner chamber 59 of the nozzle member 50 passes back through windows 58a and 58b into inner chamber 37 and then back into the bottle (not shown).

With reference to FIG. 6 a perspective external view of the nozzle member 50 of sipper cap 10 is shown. As can be seen, the nozzle member 50 includes piercing part 54 having piercing means 55. Shoulder 57b and sealing face 57a are also visible as is one of windows 58a/58b. The other window is not visible from this perspective. Also clearly visible is the retention part 56 on piercing part 54.

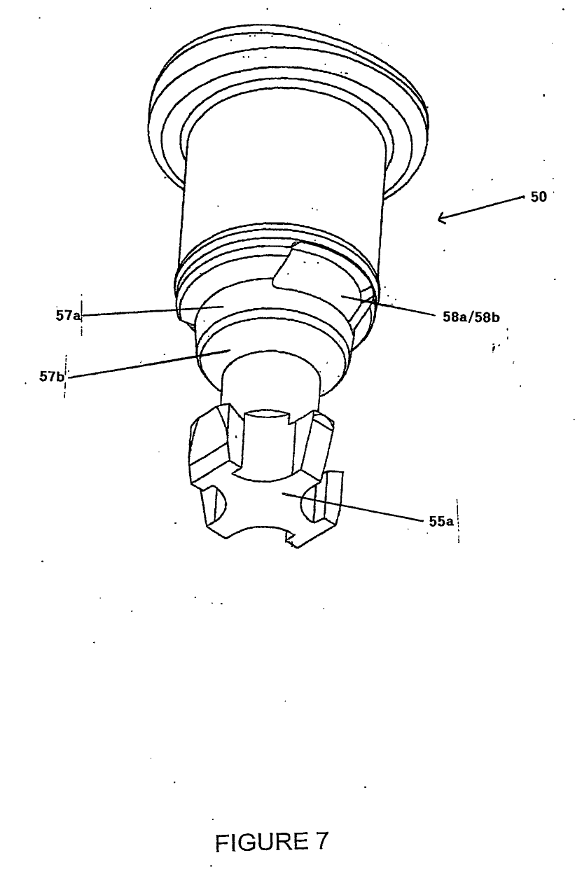

With reference to FIG. 7 a perspective external view of an alternative form of nozzle member 50 for sipper cap 10. The difference between FIG. 7 and FIG. 6 resides in the absence of piercing means 55 in the embodiment of FIG. 7. As can be seen a flat surface 55a is present instead. Such a nozzle part would be used should the option of using the cap 10 with a bottle not having a seal to be pierced be used. Alternatively, the cap 10 could be removed and the seal then removed. This is clearly less preferred.

As is readily apparent, retention part 56 shown in FIGS. 1 to 7 can be used in known sipper cap devices that do not utilise the single point seal option. This allows the important safety aspects of assisting in nozzle removal prevention to be transferred to sipper caps where the use of the single point seal is not necessary or is otherwise undesired.

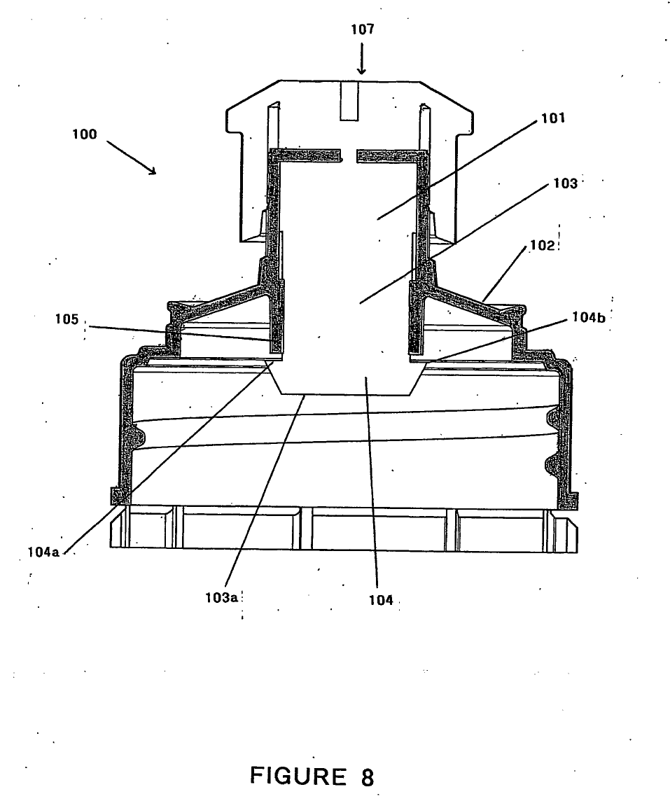

FIGS. 8 to 10 show embodiments in which a retention part is utilised in a sipper cap not including the single point seal.

The means by which known sipper caps operate to allow and prevent passage of fluid is well known to persons skilled in the art. This alternative is directed to assisting in the prevention of removal of the nozzle from the sipper cap.

As seen in FIG. 8, a cross-section of a sipper cap 100 is shown including a nozzle 101 and a housing 102. The nozzle 101 is adapted to reciprocally move within housing 102 from an open to a closed position formed by known means.

The nozzle 101 includes retention part 104 on end 103a of arm 103. The retention part 104 includes wings 104a and 104b positioned to interact with an extension 105 on housing 102 to prevent removal of nozzle 101 from housing 102, thus increasing the safety aspects of the known sipper cap arrangement. As seen in FIG. 8, wings 104a and 104b extend from arm 103 at about 900 from the central axis of nozzle 101. While the retention part 104 and wings 104a and 104b take a substantially inverted frustoconical shape, it will be appreciated that other conformations would also be able to be used. Wings 104a and 104b include surface 110 which are adapted to abut extension 105. Surface 110 extends at 900 from the central longitudinal axis of arm 103.

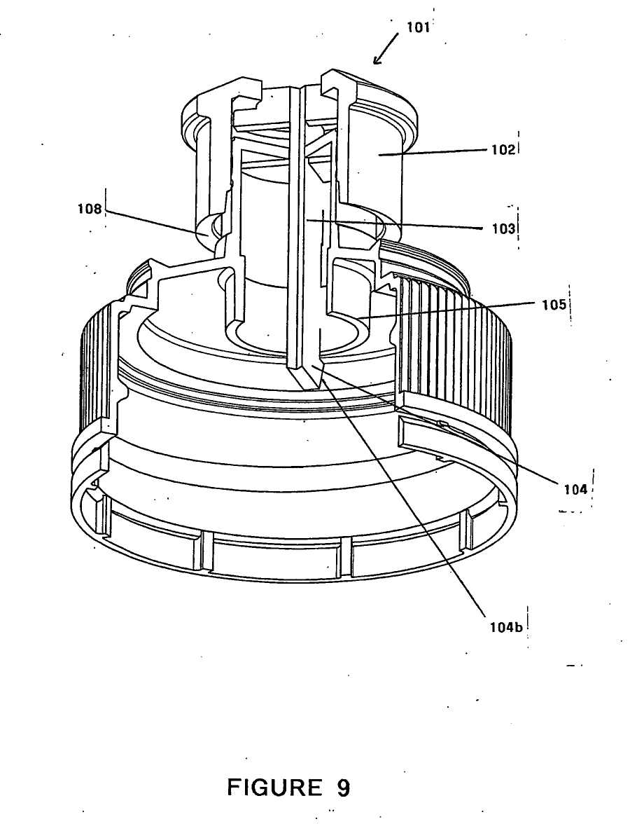

Extension 105 of housing 102 is provided to prevent nozzle 101 from moving too far out of the housing 102 before retention part 104 stops removal. Extension 104 is optional however, if such an extension is not used, the nozzle 102 will move from the housing an extended distance prior to wings 104a and 104b impacting on the housing. The use of an extension such as that shown at 105 in FIGS. 8 and 9 is preferred.

FIG. 9 shows a perspective cutaway view of the sipper cap shown in FIG. 8. Nozzle 101 is shown in an open position in housing 102 and the wing. 104b of retention part 104 on nozzle 101 is adjacent extension 105 of housing 102. Wing 104a is not shown in this Figure. The retention part 104 being positioned to prevent movement of nozzle 101 that would result, or likely result, in nozzle 101 being removed from housing 102. The extension of arm 103 from the partially closed end 107 of nozzle 101, along the central longitudinal axis of housing 102, and past the open end 108 of nozzle 101 can be readily seen in this Figure.

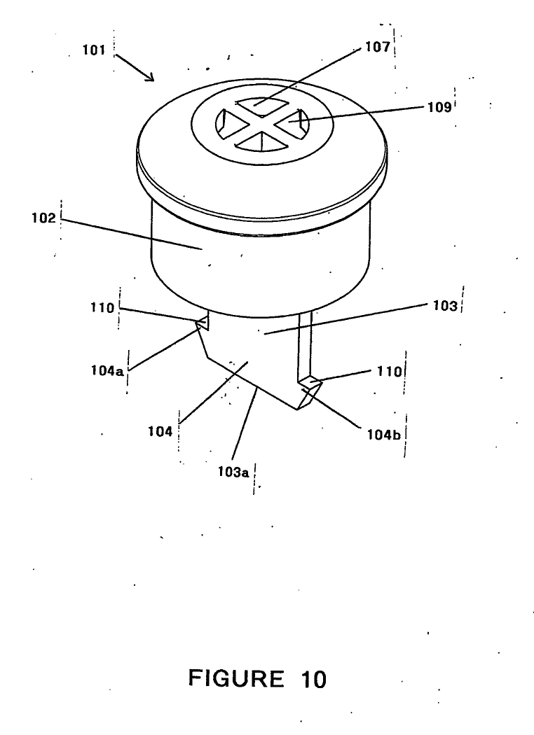

FIG. 10 shows a perspective view of nozzle 101 including retention part 104 and wings 104a and 104b. As seen in this view, partially closed end 107 of nozzle 101 includes openings 109 adapted to allow passage of liquid through the nozzle, as would be well known to a person skilled in this art. Again, the extension of arm 103 from open end 108 (not shown in FIG. 10) of nozzle 101 is shown, as are wings 104a and 104b which form substantially a “T” shape together with arm 103.

As will be readily be apparent, the arm 103 will preferably extend along the central longitudinal axis of nozzle 101 (or housing 102) but could lie adjacent, or be attached to, an internal wall of housing 102. In addition, only one wing 104a or 104b could be used, as could more than 2 wings if desired. However, a balance needs to be drawn between securing the nozzle within the sipper cap and allowing passage of liquid when desired.

The angle and shape of wings 104a and 104b from arm 103 is not critical except to the extent that the wings need to be able to retain the nozzle within a sipper cap. As such angles of surface 110 between 60° and 110° to the central longitudinal axis of the nozzle are preferred with about a 90° angle (as seen in FIGS. 8 to 10) being preferable. Reference to FIGS. 1-7 show an angular aspect to retention part 56 which is present on the “wings” of the nozzle 50.

The arm 103 as shown in FIGS. 8 to 10 extends across a substantial amount of the central area encompassed by housing 102. This is best seen in FIG. 8. The width of arm 103 is provided to allow for increased strength and ease of manufacture The conformity of fit between the extension 105 and arm 103 allows wings 104a and 104b to have increased strength that maximises removal resistance. As will be apparent, the shape of arm 103 could vary from a narrow pencil shape to the type of shape shown in FIGS. 8 to 10, however the arm must be strong enough to hold the retention part 104 securely to prevent breakage, which would allow the nozzle to be removed. The strength needed would be within the knowledge of the skilled person in this art.

While in the foregoing description there has been made reference to specific components or integers of the invention having known equivalents then such equivalents are herein incorporated as if individually set forth.

Although this invention has been described by way of example only and with reference to possible embodiments thereof it is to be understood that modifications or improvements may be made without departing from the scope or spirit of the invention.

1. A sipper cap for engagement with a container, the sipper cap including a housing and a nozzle reciprocally movable in the housing wherein the sipper cap is adapted to provide a releasable seal between the housing and the nozzle capable of preventing passage of liquid through the sipper cap.

2. The sipper cap according to claim 1 wherein the seal is a single point seal.

3. The sipper cap according to claim 1 wherein the releaseable seal is a single point seal which is formed by interaction of a concentric extension from the housing that is adapted to interact with a sealing face about the nozzle.

4. The sipper cap according to claim 3 wherein the concentric extension includes an angled surface that interacts directly with a sealing face on the nozzle.

5. The sipper cap according to claim 4 wherein the angled surface is at an angle of between about 30° and about 70° from the central longitudinal axis of the housing.

6. The sipper cap according to claim 5 wherein the angled surface at an angle of between about 45° and about 60°.

7. The sipper cap according to claim 6 wherein the angled surface is at an angle of about 55°.

8. A sipper cap including a nozzle and a housing wherein the nozzle is reciprocally movable in the housing from a closed position to an open position and, when in the closed position, a seal is created by an interaction between a concentric extension from the housing and the external surface of the nozzle.

9. The sipper cap according to any one of the precious claim wherein the sipper cap includes an induction seal at the point of interaction between the concentric extension and the nozzle surfaces.

10. The sipper cap according to claim 8 wherein the concentric extension includes an angled surface that interacts directly with sealing face on the nozzle.

11. The sipper cap according to claim 10 wherein the angled surface is at an angle of between about 30° and about 70° from the central longitudinal axis of the housing.

12. The sipper cap according to any one of the preceding claim 8 wherein the nozzle includes at least two windows for passage of fluid through the sipper cap, the passage of fluid through the window being preventable by the interaction of the concentric extension from the housing and the nozzle.

13. A sipper cap according to claim 1 wherein the cap includes an induction seal at the point of interaction between the concentric extension and the nozzle and optionally another induction seal at the point of contact between the container and the sipper cap.

14. A sipper cap for attachment to a container, the sipper cap including a nozzle and a housing, wherein the nozzle is reciprocally movable within the housing from a first to a second open position, and from the second open position to a closed position, and wherein the nozzle is restricted in movement from the first open position to the second open position, and to and from the closed position, and wherein when the nozzle is in the closed position a seal is created by an interaction between a concentric extension from the housing, and the external surface of the nozzle preventing passage of liquid through the sipper cap.

15. The sipper cap according to claim 14 wherein the container does not have a seal independent of the sipper cap and the container is purchased with the sipper cap having the nozzle in the closed position.

16. The sipper cap according to claim 14 wherein the container does have a seal independent of the sipper cap and the container is purchased with the sipper cap having the nozzle in the first open position.

17. The sipper cap according to claim 14 wherein the concentric extension includes an angled surface that interacts directly with sealing face on the nozzle.

18. The sipper cap according to claim 17 wherein the angled surface is at an angle of between about 30° and about 70° from the central longitudinal axis of the housing.

19. The sipper cap according to claim 18 wherein the angled surface is at an angle of about 55° to the central longitudinal axis of the sipper cap.

20. A housing for a sipper cap nozzle, the housing including a concentric extension with an angled end surface, the extension adapted to interact with the nozzle at the angled end surface to provide a releasable seal preventing passage of liquid through the nozzle and sipper cap.

21. The housing according to claim 20 wherein the concentric extension includes an angled surface that interacts directly with sealing face on the nozzle.

22. The housing according to claim 21 wherein the angled surface is at an angle of between about 30° and about 70° from the central longitudinal axis of the housing.

23. The housing according to claim 22 wherein the angled surface is an angle of between about 45° and about 60°.

24. The housing according to claim 23 wherein the angled surface is at an angle of about 55°.

25. A sipper cap for attachment to a container, the sipper cap including a housing and a nozzle, the nozzle being reciprocally movable within the housing from an open position allowing passage of liquid to a closed position preventing passage of liquid from the container, wherein the nozzle includes a retention part adapted to prevent removal of the nozzle from the housing.

26. The sipper cap according to claim 25 wherein the retention part is at the end of the nozzle which, when the sipper cap is attached to the container, is adapted to be positioned adjacent the container.

27. The sipper cap according to claim 25 wherein the nozzle includes a nozzle housing adapted to allow passage of liquid therethrough, the nozzle housing having an open end and a partially closed end, wherein the nozzle also includes an arm extending from the partially closed end of the nozzle housing through the open end of the nozzle housing, the arm including at least one wing extending from the end of the arm distal the partially closed end of the nozzle and being capable of preventing removal of the nozzle from the sipper cap.

28. A nozzle for a sipper cap, the nozzle including a housing adapted to allow passage of liquid therethrough, the housing having an open end and a partially closed end, wherein the nozzle also includes an arm extending from the partially closed end through the housing and extending from the open end of the nozzle, the arm including at least one wing extending from the end of the arm distal the partially closed end of the nozzle and being capable of preventing removal of the nozzle from the sipper cap.

29. The nozzle according to claim 28 wherein the wing extends at an angle of between about 70° and about 110° from the central longitudinal axis of the arm.

30. The nozzle according to claim 28 wherein the wing extends from the arm at an angle of about 90° from the longitudinal axis of the arm.

31. The nozzle according to any one of claim 28 wherein the arm including two wings and the end of the arm distal the partially closed end of the nozzle is substantially a “T” shape.

32. The nozzle according to any one of claim 28 wherein the arm extends along the central longitudinal axis of the nozzle.

33. A container including a sipper cap according to claim 1.

34-36. (canceled)

37. A container including a sipper cap according to claim 8.

38. A container including a sipper cap according to claim 14.

39. A container including a sipper cap according to claim 20.

40. A container including a sipper cap according to claim 25.

41. A container including a sipper cap according to claim 28.
